(19) United States
(12) Patent Application Publication
(10) Pub. No.: US 2024/0001333 A1
(43) Pub. Date: Jan. 4, 2024

(54) COMPOSITE MATERIALS CONTAINING CARBONATE-INFUSED ACTIVATED CARBON

(71) Applicant: Arizona Board of Regents on behalf of Arizona State University, Scottsdale, AZ (US)

(72) Inventors: Matthew Green, Phoenix, AZ (US); Klaus Lackner, Longmont, CO (US); Jae Sang Lee, Tempe, AZ (US); Meng Wang, Tempe, AZ (US); Mani Modayil Korah, Tempe, AZ (US); Husain Mithaiwala, Tempe, AZ (US); Allen Wright, Gilbert, AZ (US)

(21) Appl. No.: 18/039,338

(22) PCT Filed: Feb. 8, 2022
(86) PCT No.: PCT/US2022/015647

§ 371 Date: May 30, 2023

Related U.S. Application Data
(60) Provisional application No. 63/148,253, filed on Feb. 11, 2021.
(60) Provisional application No. 63/146,967, filed on Feb. 8, 2021.

(51) Int. Cl. B01J 20/20; B01D 53/62; B01J 20/04; B01J 20/26; B01J 20/28; B01D 53/96; B01J 20/30

(52) U.S. Cl. CPC B01J 20/20; B01D 53/62; B01J 20/043; B01J 20/267; B01J 20/28028; B01J 20/28038; B01D 53/96; B01J 20/3078; B01J 20/3007; B01D 2257/504; B01D 2258/06; B01D 2253/102; B01D 2253/202; B01D 2253/25; B01D 2251/304; B01D 2251/306; B01D 2251/606

(57) ABSTRACT

A polymer composite includes a polymer substrate, activated carbon, and a carbonate salt. The activated carbon is infused with the carbonate salt. A hybrid composite includes a fibrous mat with activated carbon and potassium carbonate crystals adhered to the fibrous mat. Making a polymer composite includes combining activated carbon with a polymer to yield a mixture, and electrospinning the mixture to yield nanofibers, wherein the carbonate salt is adhered to or embedded in the nanofibers. Capturing carbon dioxide from a quantity of air includes contacting the polymer composite with the quantity of air in the presence of water vapor to yield potassium bicarbonate sorbed on the polymer composite.

### CROSS-REFERENCE TO RELATED APPLICATIONS

This application claims the benefit of U.S. Provisional Patent Application No. 63/146,967 filed on Feb. 8, 2021, and U.S. Provisional Patent Application No. 63/148,253 filed on Feb. 11, 2021, which are incorporated herein by reference in their entirety.

### TECHNICAL FIELD

This invention relates to polymer-based sorbents that are infused with carbonate salts and carbonate-infused activated carbon to be used for direct air capture of carbon dioxide.

### BACKGROUND

Carbon dioxide sequestration by direct air capture includes the removal of carbon dioxide from the air. One method of direct air capture includes contacting air with a solution containing basic ions (e.g., hydroxide ions or bicarbonate ions), heating the resulting mixture to release the captured carbon dioxide, and reusing the hydroxide solution. Another method uses amine adsorbents in modular reactors.

### SUMMARY

This disclosure describes composites suitable for the capture of carbon dioxide from air or other gases. The composites include a polymer and activated carbon that has been infused with a carbonate salt. The polymer can be a thermoset (e.g., cured epoxy resin), thermoplastic, or thermoplastic elastomer. Moreover, the substrate can adopt any number of configurations, including thick or thin films, foams, fibers or hollow fibers, or combinations thereof.

In the case of the thermoset, an epoxy resin works as a glue that holds the activated carbon (ground or unground) on a surface of or encapsulated in the epoxy resin. A molecular weight of the epoxy resin can be selected based on the desired elastomeric properties of the composite. The activated carbon can be in a powder or other particulate form, and the carbon dioxide uptake capacity can be tuned based on the loading of the activated carbon. The carbonate can be in the form of potassium carbonate or sodium carbonate. An epoxy resin can be cured as a dense film. Reducing the film thickness can vary the amount of the activated carbon that comes into contact with air.

The composite can include a foaming agent (e.g., a volatile solvent such as isopropanol or saturated sodium bicarbonate, or a pressurized gas dissolved in the uncured epoxy resin) to yield a foam-like structure defining pores that allow for diffusion of air or other gases throughout the composite. A thickness of the foam structure can be changed by altering the ratio of polymer, activated carbon, and foaming agent, or by altering the volume of the mixture at a constant ratio of these components. A size or shape of the foam structure can be selected by providing the composite to a mold having the desired dimensions. The composites have a high degree of porosity and fast rate constants for carbon dioxide uptake (on the order of 0.03 L/s assuming a first-order sorption process) and can be regenerated after use.

The carbonate-infused activated carbon is impregnated into fibrous substrates. In one example, a woven or nonwoven fibrous mat made of activated carbon fibers can be soaked in a saturated solution of potassium carbonate or sodium carbonate. The fiber diameters, fiber packing, fiber porosity, and loading of carbonate salts influence the capacity and rate of CO₂ sorption. In another example, the carbonate-infused activated carbon particles (ground or unground, i.e., of varying size) can be mixed with a polymer in solution or in the melt and then formed into fibers. Fibers can be formed from solutions using electrospinning, dry jet wet spinning, and wet spinning. Fibers and filaments can be formed from molten polymers using extrusion and melt blowing.

In a first general aspect, a polymer composite includes a polymer substrate, activated carbon, and a carbonate salt. The activated carbon is infused with the carbonate salt.

Implementations of the first general aspect may include one or more of the following features.

In some implementations, the polymer substrate includes a thermoset, a thermoplastic, or a thermoplastic elastomer. The polymer substrate can include a cured epoxy resin. In some implementations, the polymer substrate includes a film. In some examples, a thickness of the film is in a range between about 50 μm and about 10 mm. The polymer substrate can include a fiber. In certain examples, the fiber is a hollow fiber. The polymer substrate can include a fibrous mat. In certain implementations, the polymer composite includes a foaming agent. In some implementations, the polymer substrate is in the form of a foam. In some examples, the activated carbon is dispersed throughout the polymer substrate. The activated carbon can be adhered to a surface of the polymer substrate. In certain examples, the activated carbon is in powder form. The carbonate salt can include potassium carbonate or sodium carbonate. In some implementations, the composite includes up to 40 wt % of the activated carbon.

In a second general aspect, a method of capturing carbon dioxide from a quantity of air includes contacting the polymer composite of the first general aspect with the quantity of air in the presence of water vapor to yield potassium bicarbonate. The potassium bicarbonate is sorbed on the polymer composite. Certain implementations include heating the polymer composite on which the potassium bicarbonate is sorbed to release carbon dioxide and regenerate the polymer composite.

In a third general aspect, a hybrid composite includes a fibrous mat including activated carbon and potassium carbonate crystals adhered to the fibrous mat.

In a fourth general aspect, a method of making a polymer composite includes combining activated carbon with a polymer to yield a mixture and electrospinning the mixture to yield nanofibers. The activated carbon is infused with a carbonate salt, and carbonate salt is adhered to or embedded in the nanofibers. In some implementations, the polymer includes one or more of polyacrylonitrile, polysulfone, polyvinylidenefluoride (PVDF), polystyrene, polycarbonate, poly(ethylene terephthalate), and nylon.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 shows a reaction scheme in which an epoxy polymer is formed by the reaction of an epoxy curing agent with an epoxy.

FIG. 2A depicts a cross-section of a composite film including carbonate-infused activated carbon dispersed in a polymer and disposed on a substrate.

FIG. 2B depicts a cross-section of carbonate-infused activated carbon adhered to a surface (e.g., a top surface or a bottom surface) of a polymer to form a composite film.

FIGS. 3A and 3B show epoxy composite foams with unground and ground activated carbon infused with potassium carbonate, respectively.

FIG. 4A shows a scanning electron microscope (SEM) image of pre-formed activated carbon fibrous mats. FIG. 4B shows an SEM image of pre-formed activated carbon fibrous mats after soaking in potassium carbonate solutions in order to infuse the carbonate salt into the activated carbon mats. FIGS. 4C and 4D show the sorption of carbon dioxide by the potassium carbonate-infused activated carbon mats described with respect to FIG. 4B. FIG. 4C shows the amount of CO₂ sorbed onto the sorbent per gram of sorbent as a function of time. FIG. 4D shows the total CO₂ sorbed onto the sorbent as a function of time. FIG. 4E shows the real-time concentration of CO₂ (upper curve) and H₂O (lower curve) in the atmosphere above the sorbent as a function of time.

FIG. 5A illustrates the process of forming electrospun fibrous mats that contain carbonate-infused activated carbon. FIG. 5B shows an SEM image of a polysulfone-potassium carbonate-activated carbon nanofiber composite formed using the electrospinning process illustrated in FIG. 5A. FIGS. 5C and 5D show the sorption of carbon dioxide by an electrospun polymer composite. FIG. 5C shows the amount of CO₂ sorbed onto the sorbent per gram of sorbent as a function of time. FIG. 5D shows the total CO₂ sorbed onto the sorbent as a function of time. FIG. 5E shows the real-time concentration of CO₂ (thick curve) and H₂O (thin curve) in the atmosphere above the sorbent.

### DETAILED DESCRIPTION

This disclosure describes composites suitable for the capture of carbon dioxide from air or other gases. The composites include a polymer (e.g., a resin, such as an epoxy resin) and activated carbon loaded with one or more carbonate salts. The polymer works as a glue that holds the activated carbon (ground or unground) on a surface of or encapsulated in the composite. A molecular weight of the polymer can be selected based on the desired elastomeric properties of the composite. The activated carbon can be in a powder or particulate form, and the carbon dioxide uptake capacity can be tuned based on the loading of the activated carbon and the carbonate salt. Examples of suitable carbonate salts include potassium carbonate and sodium carbonate. The composite can include a foaming agent (e.g., isopropanol or saturated sodium bicarbonate) to yield a foam-like structure defining pores that allow for diffusion of air or other gases throughout the composite. A thickness of the foam structure can be changed by altering a ratio of polymer, activated carbon, and foaming agent, or by altering the volume of the mixture at a constant ratio of these components. A size or shape of the foam structure can be selected by providing the composite to a mold having the desired dimensions. For direct air capture, the composite is contacted with a gas containing carbon dioxide in the presence of water vapor (e.g., steam), and the carbonate is converted to bicarbonate as shown for potassium carbonate below.

K₂CO₃+H₂O+CO₂→2KHCO₃

Heating the composite with sorbed carbon dioxide converts the bicarbonate back to carbonate, thereby regenerating the composite for repeated use. The composites have a high degree of porosity and fast rate constants for carbon dioxide uptake (on the order of 0.03 L/s, assuming a first-order sorption process).

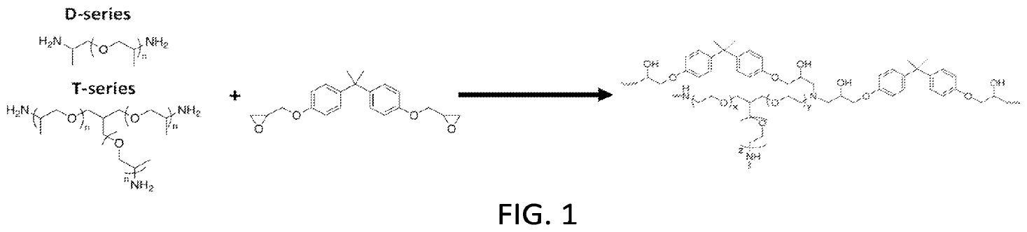

FIG. 1 is a reaction scheme showing an epoxy reacting with epoxy curing agents to form an epoxy polymer. When the reaction shown in FIG. 1 takes place in the presence of activated carbon infused with potassium carbonate, an epoxy-potassium carbonate-activated carbon composite is formed that can be used for direct air capture. Although a wide variety of polymers including epoxies and epoxy curing agents can be used, bisphenol A diglycidyl ether and D-series and T-series JEFFAMINE epoxy curing agents, respectively, are depicted as examples in FIG. 1. The activated carbon can be ground (e.g., in powder form) or unground (e.g., in larger particulate form). The mixture including the epoxy resin and the activated carbon can include up to 40 wt % activated carbon. The mixture is typically sonicated (e.g., for about 10 minutes) to disperse the activated carbon. The resulting composite is an epoxy resin with potassium carbonate-infused activated carbon dispersed throughout the composite.

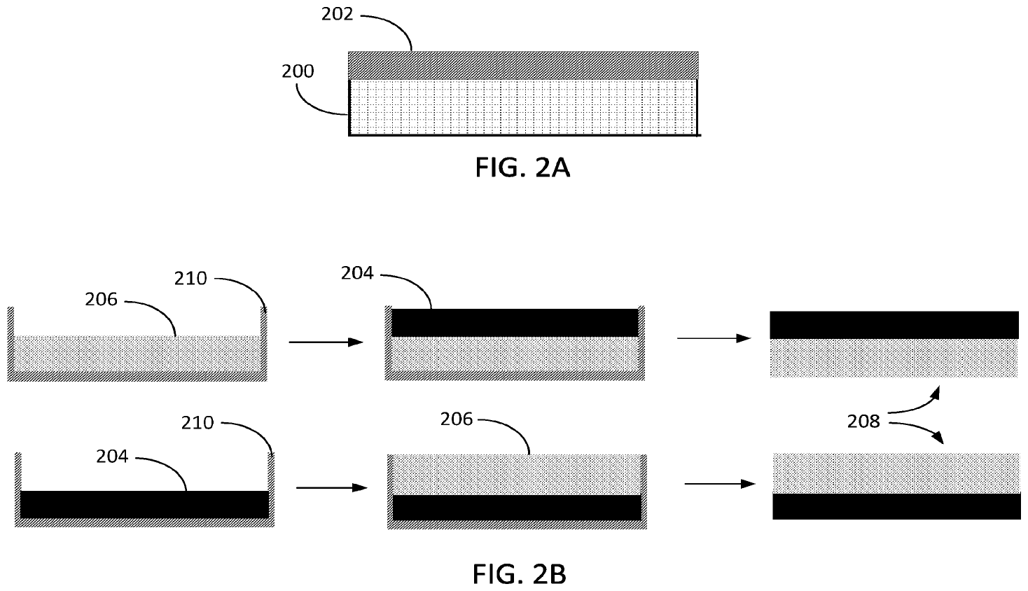

The composite including carbonate-infused activated carbon can be disposed on a substrate to yield a composite film. In the example illustrated in FIG. 2A, the carbonate-infused activated carbon is mixed throughout (e.g., encapsulated in) the polymer to yield a polymer-carbonate-infused activated carbon composite and disposed on substrate 200 to yield a homogeneous polymer-carbonate-infused activated carbon composite film 202. In one example, substrate 200 is a glass substrate. The homogeneous polymer-carbonate-infused activated carbon composite film 202 can be prepared on substrate 200 with a doctor blade.

In another embodiment depicted in FIG. 2B, the carbonate-infused activated carbon 204 is adhered to a surface (e.g., a bottom surface or a top surface) of polymer 206 to yield a heterogeneous polymer-carbonate-infused activated carbon composite film 208. In one example, polymer 206 is an epoxy resin. Spatial confinement can be achieved by placing the carbonate-infused activated carbon 204 on a top surface of the uncured epoxy resin in mold 210 followed by curing to physically lock the carbonate-infused activated carbon 204 in place. Similarly, the carbonate-infused activated carbon 204 can be placed in the bottom of mold 210 followed by pouring the epoxy resin and a curing agent on top of the carbonate-infused activated carbon. Curing of the epoxy resin followed by removal from mold 210 yields a heterogeneous epoxy resin-carbonate-infused activated carbon composite film 208.

The homogeneous and heterogeneous polymer-carbonate-infused activated carbon composite films 202 and 208, respectively, can include ground and unground activated carbon. The composite films typically include carbonate-infused ground activated carbon in a range of up to about 40 wt %. The carbonate-infused activated carbon can be adhered to one or more surfaces of the polymer. A thickness of the composite films 202 and 208 is typically in a range between about 50 μm and about 10 mm.

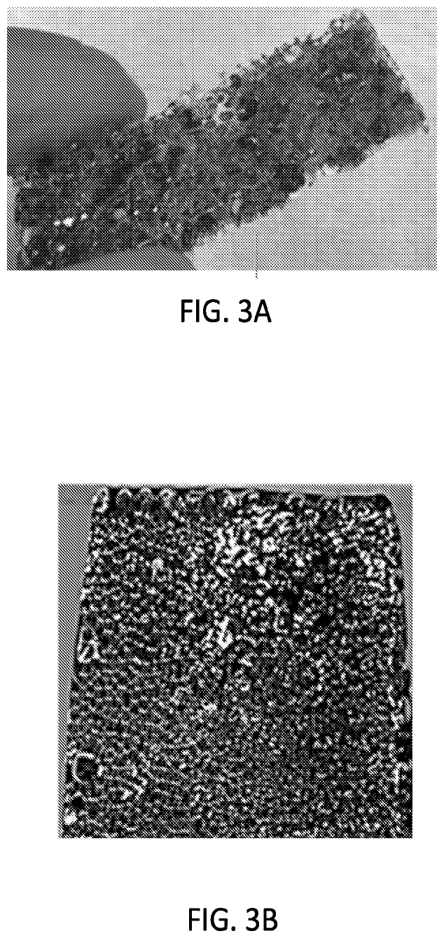

FIGS. 3A and 3B show epoxy composite foams with unground and ground activated carbon, respectively, infused with potassium carbonate. To form the composite foam example shown in FIG. 3A, a foaming agent (isopropanol) was combined with unground activated carbon to yield a mixture. The mixture (5 wt % of unground activated carbon and 33 wt % of the isopropanol) was combined with epoxy and an epoxy curing agent and cured for 20 minutes at 120° C. to yield a composite epoxy foam. Synthesis conditions for the example shown in FIG. 3B were similar to those for FIG. 3A except ground activated carbon was used in the example of FIG. 3B. 33 wt % isopropanol and a 1:167 weight ratio of epoxy resin to unground activated carbon were combined to yield a flake-like structure. In examples corresponding to FIGS. 3A and 3B, the epoxy (bisphenol A diglycidyl ether) and the epoxy curing agent (JEFFAMINE D230, D400, D2000) were mixed in a ratio by weight of 0.345:1, 0.6:1, and 3:1, respectively. In some embodiments, the composite foam is formed by combining a foaming agent (saturated sodium bicarbonate solution) with activated carbon to yield a mixture. In one example, a mixture (1 wt % saturated sodium bicarbonate and 1 g activated carbon) is combined with an epoxy and an epoxy curing agent (2 g total) and cured overnight at 120° C. to yield a composite epoxy foam with ground and unground activated carbon. The epoxy (bisphenol A diglycidyl ether) and the epoxy curing agent (JEFFAMINE D230, D400, D2000) can be mixed in a ratio of 0.345:1, 0.6:1, and 3:1, respectively.

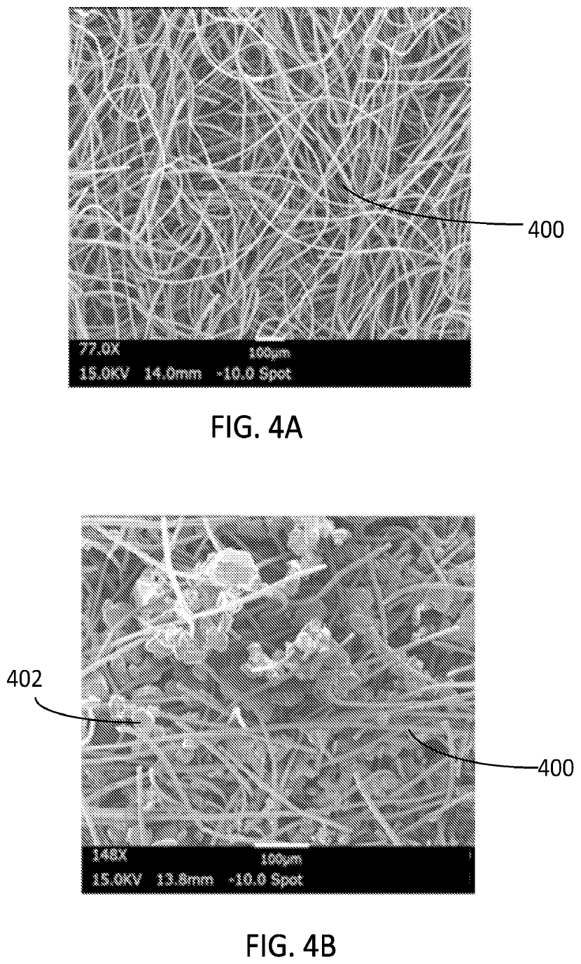

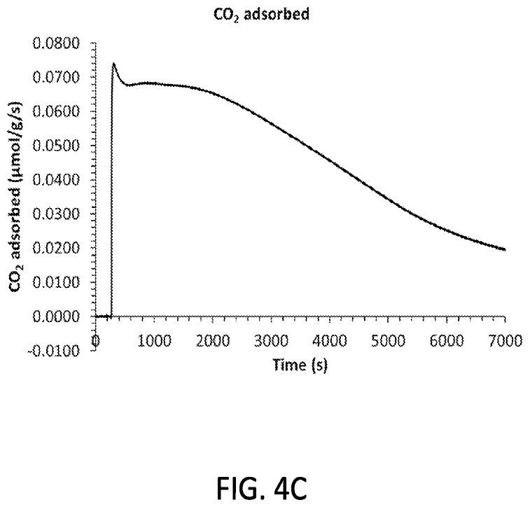

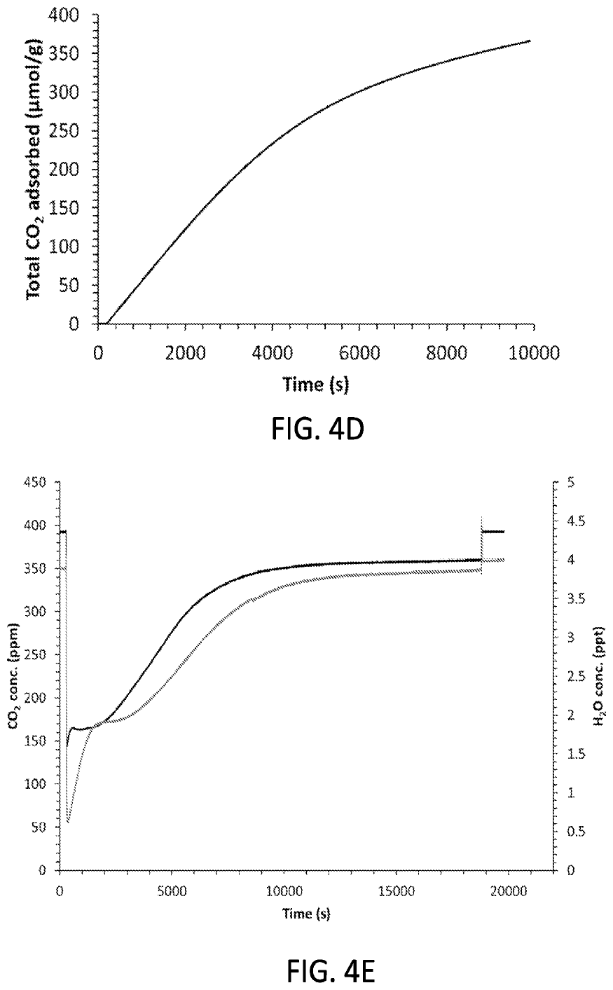

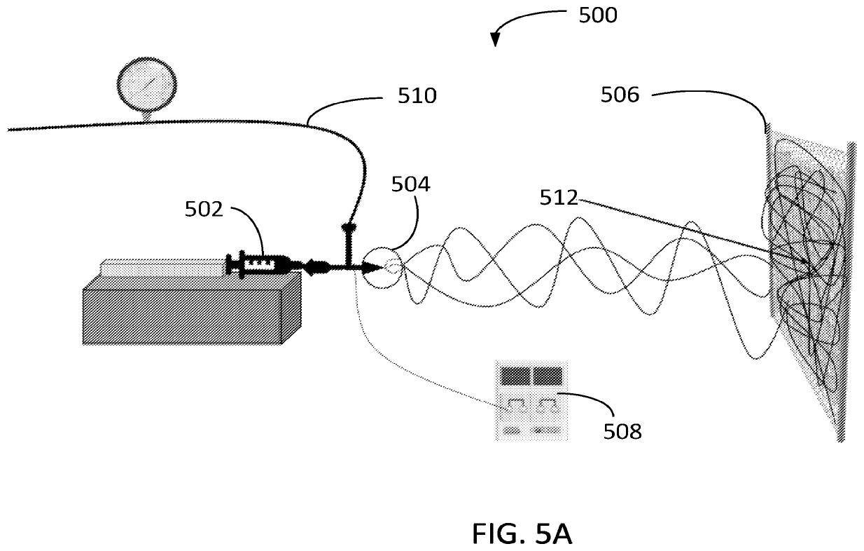

FIG. 4A shows a scanning electron microscope (SEM) image of a pre-formed (commercially available) activated carbon mat 400 (CeraMaterials). FIG. 4B shows an SEM image of an activated carbon 400 mat after it has been soaked in a saturated potassium carbonate solution under vacuum at room temperature for about 30 minutes, thereby adhering potassium carbonate crystals 402 to the activated carbon mat 400 to yield a hybrid composite. FIGS. 4C and 4D show to the sorption of carbon dioxide by the hybrid composite described with respect to FIG. 4B. FIG. 4C shows the amount of CO₂ sorbed onto the sorbent per gram of sorbent as a function of time, where the sorbent is defined as the potassium carbonate-infused activated carbon mats. The mat is heated to 125° C. for 30 minutes and subjected to 1 liters per minute (LPM) airflow. The mat can be heated to release the sorbed carbon dioxide and reused multiple times with little to no loss in capacity. FIG. 4D shows the total CO₂ sorbed onto the sorbent as a function of time. FIG. 4E shows the real-time concentration of CO₂ (upper curve) and H₂O (lower curve) in the atmosphere above the sorbent as a function of time.

Hybrid polymer composites for direct air capture of carbon dioxide can be formed by electrospinning. In one example, activated carbon is combined with a saturated potassium carbonate solution and soaked under vacuum. The activated carbon is ground into a fine powder. The carbonate-infused ground activated carbon is combined with a polymer (e.g., polyacrylonitrile, polysulfone, polyvinylidenefluoride (PVDF), polystyrene, polycarbonate, poly(ethylene terephthalate), nylon, or other polymer that can be electrospun), and the resulting mixture is electrospun to yield nanofibers with carbonate-infused ground activated carbon adhered to or embedded in the fibers.

Preparation of hybrid nanofiber composites includes infusion of carbonate into activated carbon to yield a solid mixture. The solid mixture is dispersed into a polymer solution (e.g., by continuous stirring and sonication) to yield a mixture including carbonate-infused activated carbon and the polymer. The mixture is electrospun onto a collector to yield a nanofiber composite (e.g., in the form of a membrane or mat) embedded with carbonate-infused activated carbon. A gas stream can be added to the electrospinning process to promote higher throughput and more uniform carbonate-infused activated carbon dispersion. The nanofiber composite has a high surface area to volume ratio and can be fabricated with a variety of morphologies.

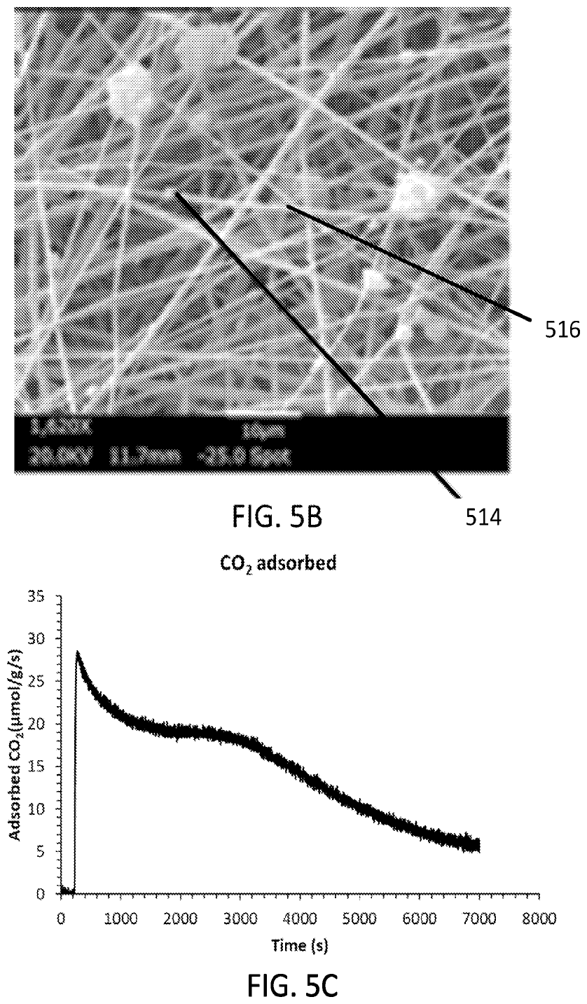

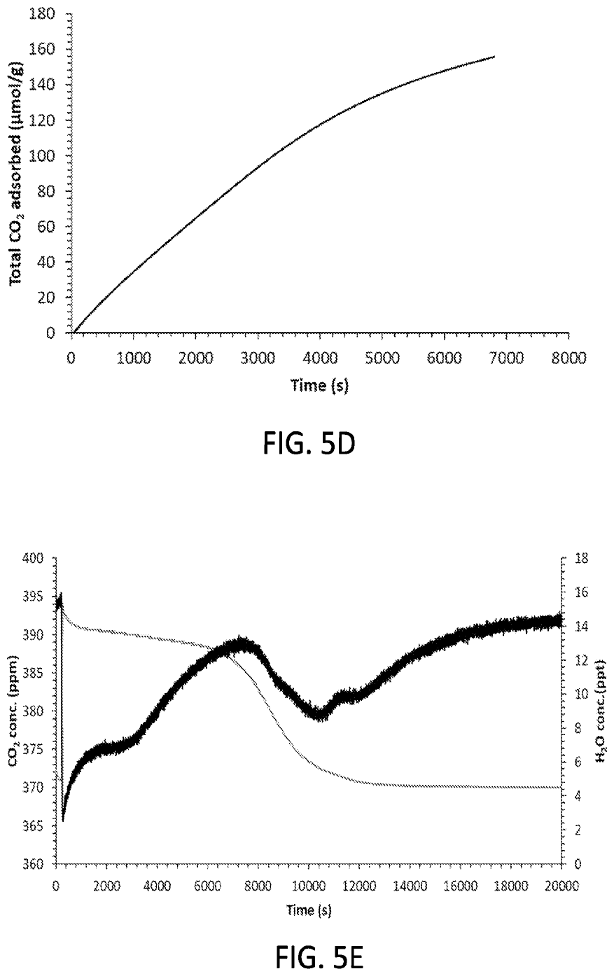

To obtain one example of a polysulfone-potassium carbonate-activated carbon nanofiber composite, a 25 wt % solution of polysulfone in solvent mixture of dimethylformamide (DMF) and tetrahydrofuran (THF) was made with a ratio of DMF:THF of 4:1 by weight. The mixture was left overnight to dissolve completely by continuous stirring at 70° C. Finely ground potassium carbonate-activated carbon (10-30 wt % of polymer) was then added to the mixture and sonicated for 30 minutes to ensure complete dispersion. The solution was then electrospun using an apparatus such as apparatus 500 depicted in FIG. 5A. The solution was loaded into syringe barrel 502 and then extruded through a 16-gauge needle 504 onto a metal collector 506 kept at a distance of 20 cm away from the needle tip. A high voltage of 22 kV was applied by a power supply 508 to drive the electrospinning process at a flow rate of 3 ml/hr. A coaxial gas flow 510 at a pressure of 20 psi was maintained to assist the electrospinning process and improve dispersion. The resulting composite 512 provides a high surface area for contact with air (and thus CO₂ in the atmosphere), enabling high loading and fast reaction kinetics.

FIG. 5B shows an SEM image of a polysulfone-potassium carbonate-activated carbon nanofiber hybrid composite formed using the electrospin apparatus illustrated in FIG. 5A. The potassium carbonate-infused ground activated carbon 514 is adhered to the electrospun fibers 516.

FIGS. 5C and 5D show the sorption of carbon dioxide by an electrospun polymer hybrid composite (10% polyacrylonitrile with 15 wt % potassium carbonate-infused ground activated carbon relative to the polyacrylonitrile). FIG. 5C shows the amount of CO₂ sorbed onto the sorbent per gram of sorbent as a function of time. FIG. 5D shows the total CO₂ sorbed onto the sorbent as a function of time. FIG. 5E shows the real-time concentration of CO₂ (thick curve) and H₂O (thin curve) in the atmosphere above the sorbent.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A polymer composite comprising:
a polymer substrate;
activated carbon; and
a carbonate salt, wherein the activated carbon is infused with the carbonate salt.

2. The composite of claim 1, wherein the polymer substrate comprises a thermoset, a thermoplastic, or a thermoplastic elastomer.

3. The composite of claim 2, wherein the polymer substrate comprises a cured epoxy resin.

4. The composite of claim 1, wherein the polymer substrate comprises a film.

5. The composite of claim 4, a thickness of the film is in a range between about 50 μm and about 10 mm.

6. The composite of claim 1, wherein the polymer substrate comprises a fiber.

7. The composite of claim 6, wherein the fiber is a hollow fiber.

8. The composite of claim 1, wherein the polymer substrate comprises a fibrous mat.

9. The composite of claim 1, wherein the polymer composite further comprises a foaming agent.

10. The composite of claim 9, wherein the polymer substrate is in the form of a foam.

11. The composite of claim 1, wherein the activated carbon is dispersed throughout the polymer substrate.

12. The composite of claim 1, wherein the activated carbon is adhered to a surface of the polymer substrate.

13. The composite of claim 1, wherein the activated carbon is in powder form.

14. The composite of claim 1, wherein the carbonate salt comprises potassium carbonate or sodium carbonate.

15. The composite of claim 1, wherein the composite comprises up to 40 wt % of the activated carbon.

16. A method of capturing carbon dioxide from a quantity of air, the method comprising:
contacting the polymer composite of claim 1 with the quantity of air in the presence of water vapor to yield potassium bicarbonate, wherein the potassium bicarbonate is sorbed on the polymer composite.

17. The method of claim 16 further comprising heating the polymer composite on which the potassium bicarbonate is sorbed to release carbon dioxide and regenerate the polymer composite.

18. A hybrid composite comprising:
a fibrous mat comprising activated carbon; and
potassium carbonate crystals adhered to the fibrous mat.

19. A method of making a polymer composite, the method comprising:
combining activated carbon with a polymer to yield a mixture, wherein the activated carbon is infused with a carbonate salt; and
electrospinning the mixture to yield nanofibers, wherein the carbonate salt is adhered to or embedded in the nanofibers.

20. The method of claim 19, wherein the polymer comprises one or more of polyacrylonitrile, polysulfone, polyvinylidenefluoride (PVDF), polystyrene, polycarbonate, poly(ethylene terephthalate), and nylon.
